(19) United States
(12) Patent Application Publication
(10) Pub. No.: US 2005/0245656 A1
(43) Pub. Date: Nov. 3, 2005

(54) Flame retardant products

(76) Inventor: Michael John Sinclair, Tarporley (GB)

Correspondence Address: FERRELLS, PLLC, P. O. BOX 312, CLIFTON, VA, 20124-1706, US

(21) Appl. No.: 10/520,342

(22) PCT Filed: Jul. 14, 2003
(86) PCT No.: PCT/GB03/03031

§ 371 Date: Jan. 5, 2005

(30) Foreign Application Priority Data
Jul. 13, 2002 (GB) 0216356.6

(51) Int. Cl. C08K 3/32

(52) U.S. Cl. 524/414

(57) ABSTRACT

A composition of matter (host material) has embodied therein a flame retardant material which comprises a combination of a phosphorus containing material which decomposes to produce phosphoric acid when exposed to flame (e.g. ammonium polyphosphate and/or melamine phosphate) and an oxygenated heterocyclic thermoplastic resin (e.g. an aldehyde resin). A blowing agent (e.g. melamine) also may be included in the flame retardant material. The thermoplastic resin encapsulates the other ingredients thus making the flame retardant melt blendable with the host material (e.g. thermoplastic polymers, thermosetting polymers, solvented systems, paper and reconstituted wood products) in which it is incorporated.

This invention relates to flame retardant products.

Flame retardant products exhibiting intumescent properties are well known. Such flame retardant products are incorporated in many compositions of matter, (host materials), especially thermoplastic polymer compositions. One such flame retardant product is a blend of a phosphoric acid producing catalyst, a charring agent and a blowing agent. The catalyst is a compound, e.g. ammonium polyphosphate, which when exposed to flame yields phosphoric acid. The charring agent can be a polyhydric alcohol, e.g. pentaerythritol, which decomposes and reacts with phosphoric acid to form a carbonaceous char. The blowing agent, e.g. melamine, when exposed to flame produces a non-flammable gas (e.g. N₂) which serves to foam and expand the carbonaceous char.

The above mentioned three component flame retardant products are powder additives which have processing limitations as they do not blend well with many compositions of matter (host materials), e.g. thermoplastics. In order to overcome these processing problems there have been attempts to encapsulate the flame retardant additives in inert polymers. However, there is a disadvantageous limit on the amount of such encapsulated flame retardant product that can be incorporated in the host materials and the encapsulants themselves are generally flammable materials.

Proprietary flame retardant products have appeared on the market which typically are reaction products of pentaerythritol and phosphate esters. These flame retardant products are melt blendable with host materials such as thermoplastic polymers. However, such proprietary flame retardant products have to be used in combination with other flame retardants. Furthermore, such proprietary materials do not contain blowing agents and so do not have the advantages of char foaming and expanding.

Conventional flame retardant compositions are described in the following prior art. WO 98/08898 discloses thermosetting resin coatings, (e.g. melamine formaldehyde), for flame retardant compositions. These thermosetting coatings are there purely for their physical effect which is to lower the surface tension of the encapsulated flame retardant particles to that of host polymers.

EP 0149813A discloses a flame proofed thermoplastic moulding material (e.g. styrene polymers) which contains a three component flame retardant mixture of phenol formaldehyde resins; a nitrogen containing organic compound (e.g. urea) and a phosphorus containing organic compound. The phenol formaldehyde resin is a thermosetting resin which is included for its thermodynamic properties.

EP 0033361A describes the coating of the flame retardant ammonium phosphate with a condensation product of melamine and formaldehyde which is a thermosetting resin. The melamine formaldehyde resin serves to provide a waterproof coating for the ammonium phosphate. EP 0035094A makes a similar disclosure to EP 0033361 A.

U.S. Pat. No. 5,643,980 discloses a flame retardant thermoplastic resin (e.g. a polyolefin) which contains a polyhydric alcohol-boric acid complex as a filler (e.g. a pentaerythritol complex) and the conventional flame retardant materials ammonium polyphosphate and melamine (or melamine derivatives).

GB 1538093 relates to aqueous compositions and intumescent foams (e.g. polyurethane forms) made therefrom comprising a urea formaldehyde resin as filler, phosphorous acid as a hardener and a carbonate of an aliphatic, araliphatic, heterocyclic-aliphatic or heterocyclic amine as a blowing agent. The urea formaldehyde resin is a thermosetting resin.

DE 2800891A discloses a self-extinguishing polymeric composition which contains as a flame retardant additive, a mixture of an ammonium or amine phosphate, a polyamide and a urea formaldehyde thermosetting resin. The polyamide is essential for flame retardant activity.

GB 1286192A discloses a thermosetting polymeric composition having conventional intumescent ingredients.

An object of the present invention is to provide a unique flame retardant product which overcomes the problems of known flame retardant products in that it is more readily blendable with many compositions of matter (host materials), particularly thermoplastic compositions, and thus imparts a higher degree of flame retardancy to the host materials.

According to the present invention, there is provided a flame retardant composition which comprises a mixture of a phosphorus containing compound which decomposes to produce phosphoric acid when exposed to flame and an oxygenated heterocyclic thermoplastic resin which is prepared by reacting an urea of the general formula (I) 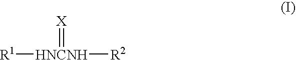
where X is oxygen or sulphur and R¹ and R² are hydrogen, identical or different alkyl of 1 to 18 carbon atoms, aryl of 6 to 9 carbon atoms or aralkyl of 7 to 9 carbon atoms or may be an alkyleneurea radical, where alkylene is of 1 to 9 carbon atoms, with at least 2 moles of a CH-acidic aldehyde of the formula (II) 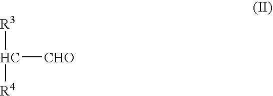
where R³ is hydrogen and R⁴ is alkyl, aryl or aralkyl, or R³ and R⁴ are identical or different alkyl, aryl or aralkyl, in the presence of a strong acid, to give a condensation product, and thereafter treating the product with an alkali metal alcoholate in an anhydrous medium.

Preferably, R³ and R⁴ in the compound of general formula (II) is alkyl of 1 to 10 carbon atoms, aryl of 6 to 9 carbon atoms or aralkyl of 7 to 9 carbon atoms.

Further preferably, the compound of general formula (I) is urea and the compound of general formula (II) is isobutyroaldehyde.

The phosphorus containing material preferably is selected from ammonium polyphosphate, sodium polyphosphate, potassium polyphosphate, melamine polyphosphate, melamine phosphate or mixtures thereof.

Advantageously, the phosphorus containing material is a mixture of ammonium polyphosphate and melamine phosphate.

The flame retardant composition may contain a blowing agent, suitably melamine or urea.

Preferably, the phosphorus containing material is encapsulated in the oxygenated heterocyclic thermoplastic resin.

Further preferably, the blowing agent and other ingredients of the flame retardant material are encapsulated in the oxygenated heterocyclic thermoplastic resin.

In this specification, the oxygenated heterocyclic thermoplastic resin is a resin prepared according to the process described in U.S. Pat. No. 4,220,751 (BASF) wherein the resin is a condensation product of an urea and a CH-acidic aldehyde. CH-acidic aldehydes are those where the carbon adjacent to the carbonyl group carries one or two hydrogen atoms.

In a preferred embodiment of the invention, the flame retardant composition comprises 25 to 60% by weight oxygenated heterocyclic thermoplastic resin; 0 to 75% by weight ammonium polyphosphate; 0 to 75% by weight melamine phosphate; and 0 to 45% by weight melamine with the proviso that ammonium polyphosphate or melamine phosphate essentially is present.

From another aspect the present invention is a composition of matter containing the flame retardant composition described and claimed herein.

The composition of matter may contain an amount of 5 to 90% by weight, preferably 10 to 45% by weight of the flame retardant composition. Higher inclusions may be desirable for masterbatches and systems requiring higher intumescent functionality.

Suitable compositions of matter (host materials), include thermoplastic polymers, thermosetting polymers, paper, reconstituted wood products and solvented systems (i.e. where the flame retardant material is dissolved in a solvent or mixtures of solvents).

Preferred host materials are polyolefins, particularly polypropylene.

From yet another aspect, the present invention is an article made from the composition of matter described above. Such articles can be made by compression moulding or injection moulding.

From yet another aspect, the present invention is a method of improving the flame retardant capability of a composition of matter by embodying in the composition of matter a flame retardant composition as described above.

Compositions of matter containing the flame retardant composition of the invention can be used in the manufacture of a wide variety of products and components for use in the electronic, construction and transport industries and can be incorporated into many structures including fire doors, vehicle passenger compartments, aircraft passenger and cargo areas as well as cargo storage containers and aircraft galley equipment, railway and underground carriages, cable trays (to prevent both loss of signal through the cable and passage of fire and heat along the cable tray itself), marine bulkheads, compressed gas and building structures.

Embodiments of the invention will now be described by way of example.

In the following examples of the invention the host material is polypropylene. The examples show that the Limiting Oxygen Index (LOI) of polypropylene incorporating the flame retardant material of the invention is increased. Since oxygen forms approximately 21% of normal atmosphere, thermoplastic polymers which have an LOI of 21% or less usually burn freely in air. If the inclusion of a material into the polymer increases the LOI of the polymer then this means that some degree of flame retardance is imparted to the polymer. As the LOI of the polymer increases above 21% then the polymer becomes increasingly difficult to ignite and also increasingly likely to self extinguish. Generally speaking, once the LOI increases to above 30% then the polymer in effect is considered to be non-flammable and an LOI of 25% indicates good flame retardancy.

Successful polypropylene formulations containing a variety of examples of the flame retardant material of the invention are illustrated in the Tables below. All of the formulations contain the essential ingredients (a) the thermoplastic resin and (b) the phosphoric acid source (ammonium polyphosphate and/or melamine phosphate and some of the formulations also include melamine as a blowing agent).

The flame retardant material of the invention is not a simple combination of the powdered components but rather it is an extrudate. The ammonium polyphosphate, melamine phosphate and melamine are effectively encapsulated in the oxygenated heterocyclic thermoplastic resin during the extrusion process. This extrudate is normally produced as a chip (but with different equipment it could be made as a pellet or prill if required). The chip can be milled to a powder if this is considered desirable.

The finished flame retardant material has the appearance of a piece of dull white plastic. The product is virtually dust free and the chip size can be varied to suit end use requirements. The flame retardant material of the invention is a melt blendable product. The oxygenated heterocyclic thermoplastic resin casing is both part of the integral flame retardant mechanism but also makes the product melt blendable with many host materials. Compared to the traditional blends of flame retardants there is no pentaerythritol present. The oxygenated heterocyclic thermoplastic resin is the charring agent as well as giving the flame retardant material its melt blendable property.

It is to be noted that the flame retardant material of the invention is not a reaction product of its ingredients but rather is a physical blend of the ingredients. To our knowledge, no other non-halogen flame retardant uses this method of having an oxygenated heterocyclic thermoplastic resin incorporated which is part of the flame retardant system. Other flame retardant systems normally use inert polymers to either encapsulate the products or as an inert backbone onto which the flame retardant molecule is grafted.

In Table 1 below, the test samples are two and three component samples produced by compression and in Table 2, the test samples are four component samples produced by injection. Table 3 shows UL94 Vertical Burning Tests of polypropylene with various loadings of the four component sample of Example 9.

In the Tables, the following terms have the following meanings:
PP means polypropylene
APP means ammonium polyphosphate
MP means melamine phosphate
the “Level” column indicates the % w/w inclusion of the flame retardant product in untreated polypropylene.
MFI refers to the Melt Flow Index—this gives an indication of how difficult the flame retardant addition makes the resulting polymer composition to process (in general the lower the MFI, the more difficult the polymer composition is to process). The MFI conditions were 230° C. and a weight of 2.16 kg.
UL94 refers to a standard test of the Underwriters Laboratory.

The ammonium polyphosphate used in the examples was Exolit AP422 from Clariant. The oxygenated heterocyclic thermoplastic resin used was Laropal A81 which is an aldehyde resin obtained from BASF. The aldehyde resin, Laropal A101, again obtainable from BASF also could be used.

The melamine phosphate used was Melapur MP obtainable from Ciba Speciality Chemicals. The melamine phosphate provides both a phosphoric acid source for the char formation and a source of melamine and so provides dual function.

The quantities expressed in the Tables are weight percentages.

TABLE 1

| | Aldehyde | | | | | |
|---|---|---|---|---|---|---|
| Example | Resin | APP | MP | Melamine | Level | LOI |
| Blank | 0 | 0 | 0 | 0 | 0 | 17 |
| PP | | | | | | |
| 1 | 40 | 0 | 60 | 0 | 20 | 19 |
| 2 | 40 | 40 | 0 | 20 | 20 | 21 |
| 3 | 40 | 40 | 20 | 0 | 20 | 23 |
| 4 | 35 | 65 | 0 | 0 | 20 | 22.5 |
| 5 | 45 | 55 | 0 | 0 | 20 | 20 |

TABLE 2

| Exam- | Aldehyde | | | | | | UL94 |
|---|---|---|---|---|---|---|---|
| ple | Resin | APP | MP | Melamine | Level | LOI | (1.6 mm) |
| 6 | 40 | 40 | 10 | 10 | 30 | 24.8 | Full Burn |
| 7 | 35 | 55 | 5 | 5 | 30 | 31.3 | Full Burn |
| 8 | 35 | 45 | 10 | 10 | 30 | 31.3 | V0 |
| 9 | 35 | 50 | 7.5 | 7.5 | 30 | 33.2 | V0 |

TABLE 3
Specimen Dimensions (mm):

| | |
|---|---|
| Length: | 125 |
| Width: | 13 |
| Thickness: | 0.8 |
| Conditioning Procedure: | 230° C. and 50% relative humidity |

| | UI94 Vertical Burning Test | | | | | | |
|---|---|---|---|---|---|---|---|
| | | | | Burned | | | |
| | Afterflame | Afterflame | Total | to the | Cotton | Classification | |
| Sample | Time 1 (s) | Time (s) | Time (s) | clamp | ignited | Single | Overall |
| 20% | 1 | 0 | 1 | N | Y | V-2 | V-2 |
| Ex. 9 | 0 | 0 | 0 | N | Y | V-2 | |
| | 0 | 0 | 0 | N | Y | V-2 | |
| | 0 | 0 | 0 | N | Y | V-2 | |
| | 0 | 0 | 0 | N | N | V-0 | |
| | Total: 1 | | Av: 0 | | | | |
| 25% | 0 | 0 | 0 | N | Y | V-2 | V-2 |
| Ex. 9 | 0 | 0 | 0 | N | N | V-0 | |
| | 0 | 0 | 0 | N | N | V-0 | |
| | 0 | 0 | 0 | N | N | V-0 | |
| | 0 | 0 | 0 | N | N | V-0 | |
| | Total: 0 | | Av: 0 | | | | |
| 25% | 0 | 0 | 0 | N | N | V-0 | V-0 |
| Ex. 9 | 0 | 0 | 0 | N | N | V-0 | |
| REPEAT | 0 | 0 | 0 | N | N | V-0 | |
| | 0 | 0 | 0 | N | N | V-0 | |
| | 0 | 0 | 0 | N | N | V-0 | |
| | Total: 0 | | Av: 0 | | | | |
| 30% | 0 | 0 | 0 | N | N | V-0 | V-0 |
| Ex. 9 | 0 | 0 | 0 | N | N | V-0 | |
| | 0 | 0 | 0 | N | N | V-0 | |
| | 0 | 0 | 0 | N | N | V-0 | |
| | 0 | 0 | 0 | N | N | V-0 | |

| | |
|---|---|
| Total: 0 | Av: 0 |

Observations from the Tables
(i) It is possible to improve the LOI of polypropylene using an intumescent system comprising only two components (aldehyde resin+MP—Ex 1) and (aldehyde resin+APP—Examples 4 & 5).
It is also possible to improve the LOI of polypropylene with three component systems (Examples 2 and 3).
(iii) The most successful results are with four component intumescent systems Examples 6, 7, 8 and 9).
(iv) Table 2 shows that formulations can be prepared to achieve LOI results of 33.2.
(v) Table 3 shows that UL94 VO ratings can be achieved at a thickness of 0.8 mm.

There now follows graphs depicting the smoke reduction, heat release and MFI properties of the flame retardant product of the invention. In the graphs, the flame retardant product designated 457X is the four component sample of Example 9 in Table 2. [image]
Cone Calorimeter Cumulative Smoke Results (50 kW)
Flame retardant of Example 9 incorporated at 30% in polypropylene. BRFR is a polypropylene flame retarded with 21% decabromo diphenyl ether and 12% antimony trioxide. [image]
Cone Calorimeter Cumulative Smoke Results (50 kW)
PP=Polypropylene, flame retardant of Example 9 included at 25% and 30% in PP

The Graphs A and B above show the significant reduction in cumulative smoke, which can be achieved when the flame retardant product of the invention is incorporated in PP. The smoke produced from the polymer can be reduced by up to 75%. More significantly however, when compared to brominated flame retardants systems, the invention produces only 2% of the total smoke evolved from the brominated systems. This is an extremely important factor as while a fire is developing, smoke is as big a threat to life as the fire is itself. [image]
Cone Calorimeter Heat Release Rates (50 kW)
PP=Polypropylene. Flame retardant of Example 9 incorporated at 30% in polypropylene. BRFR is a polypropylene flame retarded with 21% decabromo diphenyl ether and 12% antimony trioxide.

Graph C shows the heat release rates for three systems, untreated PP, PP treated with brominated flame retardants and PP treated with the flame retardant invention. The heat release rate is important as it shows how much energy a system will add to the development of a fire. The untreated PP shows a significant peak after 100s, which demonstrates it will contribute significantly to any fire development in the early stages. The brominated flame retardant works by increasing the resistance to ignition, which is demonstrated in the graph by the delay in reaching the peak HRR by 60 seconds. However, once ignited this system liberates as much energy as the untreated PP at the maximum HRR peak. The system containing the flame retardant of the invention shows no significant peak in the HRR and plateaus at a level 70% below the peak HRRs of the untreated PP and brominated flame retardant systems. This demonstrates that the flame retardant of the invention when incorporated in a polymer will not only help increase the resistance to ignitability but will also reduce the contribution the polymer will make to the development of a fire. [image]
Melt Flow Index (MFI) Comparisons (230° C., 2.19 kg)
Polymer=polypropylene, flame retardant of Example 9 included at 25% and 30% in PP.

Melt Flow Index measures the amount of polymer which can be extruded in a 10 minute period, for a given temperature and force/weight. Essentially this can be considered as a measure of how easily a given polymer can be processed, the higher the value the easier processing should be. Graph D shows the effect of adding the flame retardant of the invention to PP. In general the addition of the flame retardant of the invention will increase the MFI, so making it easier to process the polymer.

1. A flame retardant composition which comprises a mixture of a phosphorus containing compound which decomposes to produce phosphoric acid when exposed to flame and an oxygenated thermoplastic heterocyclic resin which is prepared by reacting an urea of the general formula (I) 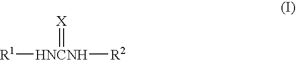
where X is oxygen or sulphur and R¹ and R² are hydrogen, identical or different alkyl of 1 to 18 carbon atoms, aryl of 6 to 9 carbon atoms or aralkyl of 7 to 9 carbon atoms or may be an alkyleneurea radical, where alkylene is of 1 to 9 carbon atoms, with at least 2 moles of a CH-acidic aldehyde of the formula (II) 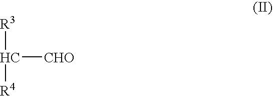
where R³ is hydrogen and R⁴ is alkyl, aryl or aralkyl, or R³ and R⁴ are identical or different alkyl, aryl or aralkyl, in the presence of a strong acid, to give a condensation product, and thereafter treating the product with an alkali metal alcoholate in an anhydrous medium.

2. A flame retardant composition as claimed in claim 1 wherein the compound of general formula (I) is urea.

3. A flame retardant composition as claimed in claim 1 wherein R³ and R⁴ in the compound of general formula (II) is alkyl of 1 to 10 carbon atoms, aryl of 6 to 9 carbon atoms or aralkyl of 7 to 9 carbon atoms.

4. A flame retardant composition as claimed in claim 1 wherein the compound of general formula (I) is isobutyroaldehyde.

5. A flame retardant composition as claimed in claim 1 wherein the phosphorus containing material is selected from ammonium polyphosphate, sodium polyphosphate, potassium polyphosphate, melamine polyphosphate or mixtures thereof.

6. A flame retardant composition as claimed in claim 5 wherein the phosphorus containing material is a mixture of ammonium polyphosphate and melamine phosphate.

7. A flame retardant composition as claimed in claim 1 which contains a blowing agent which produces a non-flammable gas when exposed to flame.

8. A flame retardant composition as claimed in claim 7 wherein the blowing agent is melamine or urea.

9. A flame retardant composition as claimed in claim 1 wherein the phosphorous containing material is encapsulated in the oxygenated heterocyclic thermoplastic resin.

10. A flame retardant composition as claimed in claim 7 wherein the blowing agent also is encapsulated in the oxygenated heterocyclic thermoplastic resin.

11. A flame retardant composition as claimed in claim 1 which is prepared by extrusion.

12. A flame retardant composition as claimed in claim 1 wherein the flame retardant composition comprises 25 to 60% by weight oxygenated heterocyclic thermoplastic resin; 0 to 75% by weight ammonium polyphosphate;
0 to 75% by weight melamine phosphate and 0 to 45% by weight melamine with the proviso that ammonium polyphosphate or melamine phosphate essentially is present.

13. A composition of matter which contains a flame retardant composition as claimed in claim 1.

14. A composition of matter as claimed in claim 13 wherein the flame retardant composition is present in the composition of matter in an amount of 5 to 90% by weight.

15. A composition of matter as claimed in claim 14 wherein the flame retardant composition is present in the composition of matter in an amount of 10 to 45% by weight.

16. A composition of matter as claimed in claim 13 selected from thermoplastic polymers, thermosetting polymers, paper, reconstituted wood products and solvented systems.

17. A composition of matter as claimed in claim 16 which is a polyolefin.

18. A composition of matter as claimed in claim 17 wherein the polyolefin is polypropylene.

19. An article formed from a composition of matter as claimed in claim 13.

20. An article as claimed in claim 19 formed by injection moulding or compression moulding.

21. A method of improving the flame retardant capability of a composition of matter by embodying in the composition of matter a flame retardant composition as claimed in claim 1.
